(19) United States
(12) Patent Application Publication
(10) Pub. No.: US 2005/0252700 A1
(43) Pub. Date: Nov. 17, 2005

(54) Powered manual propelling vehicle

(76) Inventors: Chin Kitauchi, Tokyo (JP); Takayuki Kai, Tokyo (JP)

Correspondence Address: Satoru Takeuchi;Takeuchi & Takeuchi, Suite 310, 1700 Diagonal Road, Alexandria, VA, 22314, US

(21) Appl. No.: 10/516,499

(22) PCT Filed: Jun. 2, 2003
(86) PCT No.: PCT/JP03/06974

§ 371 Date: Dec. 2, 2004

(30) Foreign Application Priority Data
Jun. 4, 2002 (JP) 2002-162701

(51) Int. Cl. B60K 1/00

(52) U.S. Cl. 180/65.1

(57) ABSTRACT

In a manual propelling vehicle (1) that a user grips its handle (30) and drives with the vehicle tilted with wheels (20) as fulcrums, a powered manual propelling vehicle comprises a motor (50) for driving wheels, a battery (60) as a power source for the motor and a control section (70) for controlling the motor, wherein the vehicle distributes its weight such that a center of gravity (G₁) of the entire vehicle is located substantially on a vertical line intersecting an axis of rotation of the wheels when the cart is traveling. The vehicle is provided with a carrier (90) to which the wheels are mounted, and the carrier is disposed foldably. The control section (70) sets the target traveling speed of the vehicle and the upper limit of the torque of the motor according to the traveling speed detected by a traveling speed detecting means, and controls the motors such that the traveling speed of the vehicle agrees with the target traveling speed in a range that the torque of the motor does not exceed the upper limit.

### TECHNICAL FIELD

The present invention relates to a powered manual propelling vehicle which is a vehicle manually driven and has motor driven wheels.

### BACKGROUND ART

Generally, there is known a powered manual propelling vehicle of which a handle for driving by manpower is gripped to drive the vehicle while tilting it with its wheels as fulcrums. A powered manual propelling vehicle of such a type is disclosed in, for example, Japanese Patent Laid-Open Publications No. 2001-120323 and No. 2001-170235.

To drive the vehicle in a tilted style as described above, a user must support some of its weight. Therefore, if the vehicle is relatively heavy, there is a disadvantage that its carrying work is somewhat difficult.

Therefore, even such a vehicle to be driven by human power is proposed to be a powered manual propelling vehicle whose wheels are driven by a motor in order to reduce a burden on the user in these years.

Such a powered manual propelling vehicle is disclosed in, for example, Japanese Patent Laid-Open Publications No. 2002-87269 and No. 2002-193105.

However it should be noted that, the above-described powered manual propelling vehicle has very important objects to be attained such as reduction of a burden on a user, assurance of a weight balance, facilitation of manual operation, simplification of a structure, an improvement of convenience, and rationalization of motor control. This powered manual propelling vehicle is further demanded to have an improved structure in view of various matters such as the reduction of a burden on the user and the like.

The present invention has been made under the circumstances described above and provides a more rationalized powered manual propelling vehicle.

### SUMMARY OF THE INVENTION

The invention described in claim 1 of the present application is a manual propelling vehicle that a user grips its handle and drives with the vehicle tilted with wheels as fulcrums, wherein a powered manual propelling vehicle comprises a motor for driving wheels, a battery as a power source for the motor and a control section for controlling the motor, and the vehicle distributes its weight such that a total center of gravity of the entire vehicle is substantially located on a vertical line intersecting an vehicle of rotation of the wheels when the cart is traveling.

According to the invention of this claim, the center of gravity of the entire vehicle is substantially on the vertical line intersecting the axis of rotation of the wheels, and the user can drive the vehicle with feeling substantially no weight of the vehicle.

Thus, the present invention is a powered manual propelling vehicle which can provide an outstanding effect of reducing a burden on the user as much as possible by securing a good weight balance of the vehicle when driving.

The invention described in claim 2 of the present application is the powered manual propelling vehicle according to the invention of claim 1, wherein the weight of the entire vehicle is a weight including a baggage loaded.

Here, the weight of the loaded baggage is estimated to be high when it is large and to be low when it is small according to an embodiment that the present invention is practiced. As will be described later, when the present invention is a golf cart, the weight of a golf club to be loaded is estimated in advance, and it is included in the weight of the entire vehicle.

The invention described in claim 3 of the present application is the powered manual propelling vehicle according to the invention of claim 1, wherein the centers of gravity of the motor and the battery are positioned on the side opposite to the handle with respect to a vertical line intersecting the axis of rotation of the wheels when the vehicle is running.

Specifically, where the center of gravity of the entire vehicle is considered, the layout of the motor and the battery is very important. According to the invention of this claim, the weight balance of the vehicle when it is running can be secured satisfactorily by determining that the centers of the gravity of the motor and the battery are positioned away from the handle when the vehicle is running.

The invention described in claim 4 of the present application is a manual propelling vehicle that a user grips its handle and drives while tilting the vehicle with wheels as fulcrums, wherein a powered manual propelling vehicle has a case section for containing there is a loaded baggage, and where in formed integrally with the vehicle.

According to the invention of this claim, this powered manual propelling which does not run with a caddie bag loaded like a golf cart but has the case section for containing therein the golf club, and which is formed integrally with the vehicle, and the golf club is contained in the case section. Therefore, when it is not in use, it serves as a caddie bag, and when it is in use, it can function as a caddie cart.

Thus, the invention of this claim does not require unloading of the loaded baggage even if the vehicle's use mode changes when it is traveling or in storage. Therefore, a burden on the user can be reduced as much as possible, and an outstanding effect of enhancing the convenience can be provided.

The invention described in claim 5 of the present application is a manual propelling vehicle that a user grips its handle and drives with the vehicle tilted with wheels as fulcrums, wherein a powered manual propelling vehicle comprises a motor for driving wheels, a battery as a power source for the motor, a control section for controlling the motor and a carrier provided with the wheels; and the motor, the battery and the control section are mounted on the carrier.

According to the invention of this claim, the carrier has the wheels, the motor, the battery and the control section, so that the carrier constitutes a unitized running mechanism section of the vehicle. Thus, when the running mechanism section is unitized, it is convenient for manufacturing and maintenance of the vehicle.

The invention described in claim 6 of the present application is a manual propelling vehicle that a user grips its handle and drives with the vehicle tilted with wheels as fulcrums, wherein a powered manual propelling vehicle comprises a motor for driving wheels, a battery as a power source for the motor, a control section for controlling the motor and a carrier provided with the wheels; and the carrier is mounted foldably.

According to the invention of this claim, the carrier having the wheels mounted is folded, so that it is quite convenient because the vehicle can be made compact as required.

The invention described in claim 7 of the present application is a manual propelling vehicle that a user grips its handle and drives with the vehicle tilted with wheels as fulcrums, wherein a powered manual propelling vehicle comprises motors for driving wheels, a battery as a power source for the motors, a control section for controlling the motors and a carrier provided with the wheels, the wheels are disposed as a pair on both sides, and the motors are disposed each for each of the pair of wheels disposed on both sides.

According to the invention of this claim, one pair of wheels on both sides are separately driven by the individual motors, so that the individual wheels are driven independently. This independent drive of the individual wheels enables to realize a high torque of the individual wheels, and the individual motors are controlled to produce differential motion between the wheels. As a result, a steering property such as a change of course is improved.

The invention described in claim 8 of the present application is the powered manual propelling vehicle according to the invention of any of claims 1 to 7, wherein the motor, the battery and the control section are connected by a harness for the power or a harness for a signal line.

Regardless of whether the carrier having the wheels mounted is stationary or mobile, it is connected by the harness for the power or the harness for a signal line as required.

The invention described in claim 9 of the present application is the powered manual propelling vehicle according to the invention of any one of claims 1 to 8, wherein the handle is provided with a manual switch for operating the motor.

According to the invention of this claim, the wheels can be driven as desired by operating the manual switch. And, when the handle is provided with the manual switch, the operation can be made with ease and it is very convenient.

The invention described in claim 10 of the present application is the powered manual propelling vehicle according to the invention of claim 9, wherein the manual switch is a rotary switch, a seesaw switch or a push switch.

Specifically, the rotary switch, the seesaw switch or the push switch can be used suitably as the manual switch.

The invention described in claim 11 of the present application is a manual propelling vehicle that a user grips its handle and drives with the vehicle tilted with wheels as fulcrums, wherein a powered manual propelling vehicle comprises a motor for driving wheels, a battery as a power source for the motor, a control section for controlling the motor and having a traveling speed detecting means for detecting the traveling speed of the vehicle, the control section sets the target traveling speed of the vehicle and the upper limit of the torque of the motor according to the traveling speed detected by the traveling speed detecting means, and controls the motor such that the traveling speed agrees with the target traveling speed within a range that the torque of the motor does not exceed the upper limit of the torque.

According to the invention of this claim, the motor can be controlled to meet the will of the user to run the vehicle, so that a powered manual propelling vehicle excelling in operability can be obtained.

For example, when the vehicle is manually accelerated by the user, the control section sets the target traveling speed and the upper limit of the torque of the motor according to the detected traveling speed and controls the motor according to them.

Specifically, when the vehicle is once accelerated, it runs by itself while keeping the target traveling speed. Besides, if the user applies a load to the vehicle traveling by itself, the vehicle is decelerated forcibly if the force of the load exceeds the upper limit of the torque of the motor. And, the control section newly sets the target traveling speed and the upper limit of the torque of the motor according to the decelerated traveling speed. Thus, the motor control can be realized to meet the user's will of running the vehicle.

The invention described in claim 12 of the present application is the powered manual propelling vehicle according to the invention of any of claims 1 to 11, wherein the motor and the wheels are coupled via an electromagnetic clutch.

According to the invention of this claim, the motor and the wheels can be connected and disconnected by the electromagnetic clutch to prevent an unnecessary load from being applied to the motor.

The invention described in claim 13 of the present application is the powered manual propelling vehicle according to the invention of any one of claims 1 to 12, wherein the motor and the wheels are coupled via a one-way clutch.

According to the invention of this claim, the motor and the wheels can be connected to rotate in one direction only by the one-way clutch.

The invention described in claim 14 of the present application is the powered, manual propelling vehicle according to the invention of any one of claims 1 to 13, wherein a tilted state detecting means for detecting the tilted state of the vehicle is provided, and the control section controls the motor according to the tilted state of the vehicle detected by the tilted state detecting means.

According to the invention of this claim, the motor is controlled according to the tilted state of the vehicle, so that the powered manual propelling vehicle having a more outstanding steering property can be obtained.

The invention described in claim 15 of the present application is the powered manual propelling vehicle according to the invention of any one of claims 1 to 14, wherein the vehicle is provided with a module capable of communicating with the outside.

According to the invention of this claim, general versatility of the powered manual propelling vehicle improved and it is quite convenient because appropriate information can be transmitted and received by the module which can communicate with the outside.

The invention described in claim 16 of the present application is the powered manual propelling vehicle according to the invention of any one of claims 1 to 15, wherein the forward end of the handle is slidable, and a liquid crystal display is mounted on the forward end.

According to the invention of this claim, appropriate data can be shown by the mounted liquid crystal display and it is quite convenient.

The invention described in claim 17 of the present application is the powered manual propelling vehicle according to the invention of claim 16, wherein the vehicle is provided with a case body, and the liquid crystal display is so provided to the positioned within the case body when the handle is retracted.

According to the invention of this claim, the liquid crystal display is covered with and protected by the case body.

The invention described in claim 18 of the present application is the powered manual propelling vehicle according to the invention of any one of claims 1 to 17, wherein the vehicle is provided with the case body having a golf club therein, the golf club has an IC chip attached, the case body is provided with an antenna and also a detection device for detecting an identification code of the IC chip, and the identification code of the IC chip is detected by the detection device to identify the movement of the golf club when the IC chip passes near the antenna.

According to the invention of this claim, a situation that a golf club is left behind when playing can be prevented.

The invention described in claim 19 of the present application is the powered manual propelling vehicle hand-driven cart according to the invention of claim 18, further comprising a means for judging the movement of the vehicle, wherein the detection device detects that the golf club is not returned to the case body and issues a voice or shows on the liquid crystal display according to the means which judges the movement of the cart.

According to the invention of this claim, when the powered manual propelling vehicle moves without returning the once taken-out golf club to the case body, voice is issued or indication is made on the liquid crystal display according to the means for judging the movement, for example, a motor rotation signal or the like, so that it is prevented that the player leaves a golf club behind.

### BRIEF DESCRIPTION OF THE DRAWINGS

FIG. 1 is an explanatory diagram showing one side of a powered manual propelling vehicle (stopped state) according to an embodiment of the present invention;

FIG. 2 is an explanatory diagram showing one side of the powered manual propelling vehicle (traveling) according to the embodiment of the present invention;

FIG. 3 is a perspective sectional view showing the front of main members of the powered manual propelling vehicle according to the embodiment of the present invention;

FIG. 4 is a perspective sectional view showing the top surface of the powered manual propelling vehicle according to the embodiment of the present invention;

FIG. 5 is a perspective sectional view showing the top surface of the powered manual propelling vehicle according to the embodiment of the present invention;

FIG. 6 is a perspective sectional view showing the top surface of the powered manual propelling vehicle according to the embodiment of the present invention;

FIG. 7 is an appearance diagram showing a handle according to the embodiment of the present invention;

FIG. 8 is an explanatory diagram showing a motor driving structure according to the embodiment of the present invention;

FIG. 9 is an appearance diagram showing a handle according to the embodiment of the present invention;

FIG. 10 is an appearance diagram showing a handle according to the embodiment of the present invention;

FIG. 11 is an explanatory diagram showing a configuration of information communications with the outside according to the embodiment of the present invention;

FIG. 12 is an explanatory diagram showing a configuration of information communications with the outside according to the embodiment of the present invention.

FIG. 13 is an explanatory diagram showing one side of a powered manual propelling vehicle (carrier-folded state) according to an embodiment of the present invention;

FIG. 14 is an explanatory diagram showing one side of the powered manual propelling vehicle (stopped state with the carrier open) according to the embodiment of the present invention;

FIG. 15 is an explanatory diagram showing one side of the powered manual propelling vehicle (when traveling) according to the embodiment of the present invention;

FIG. 16 is an explanatory diagram showing a motor driving structure according to an embodiment of the present invention;

FIG. 17 is a graph showing a relationship between a traveling speed and a target traveling speed according to the embodiment of the present invention;

FIG. 18 is a graph showing a relationship between a target traveling speed and the upper limit of ON duty according to the embodiment of the present invention;

FIG. 19 is a flow chart showing the control of the powered manual propelling vehicle according to the embodiment of the present invention;

FIG. 20 is an appearance diagram showing a case body and a handle retractable into it according to an embodiment of the present invention; and

FIG. 21 is an appearance diagram view showing the grip of a golf club and an IC chip fitted to it according to an embodiment of the present invention.

### BEST MODE FOR CARRYING OUT THE INVENTION

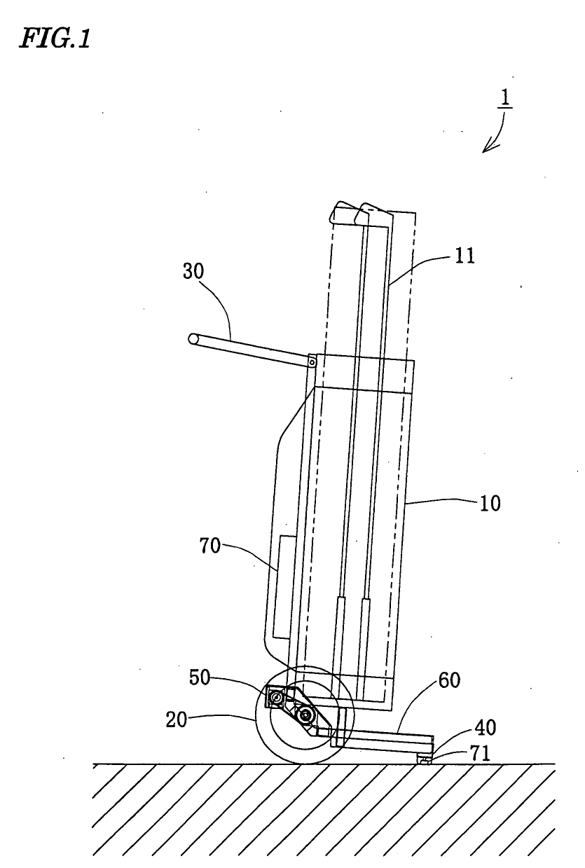

A first embodiment of the present invention will be described with reference to FIG. 1 to FIG. 12.

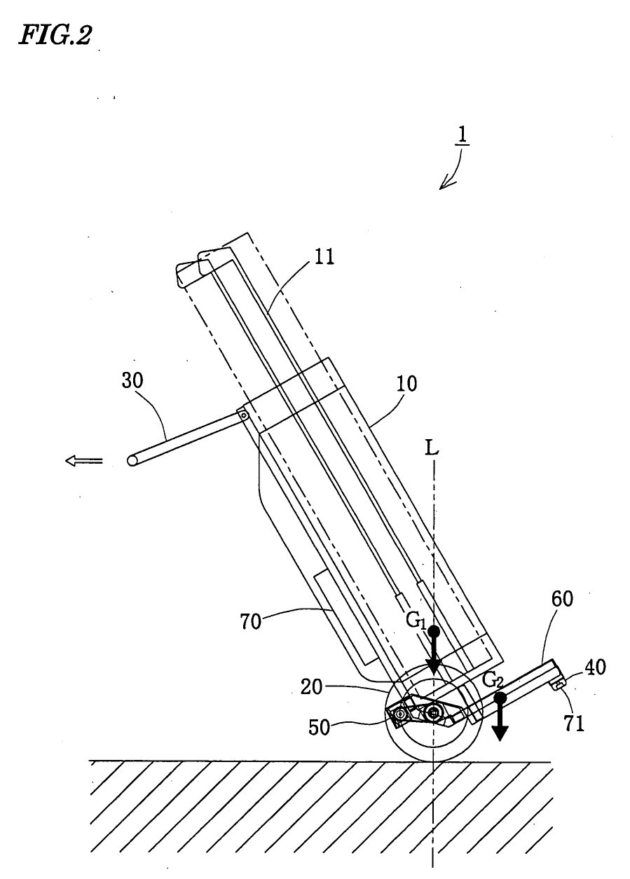

As shown in FIG. 1 and FIG. 2, a powered manual propelling vehicle 1 is a golf bag which has wheels 20 and a handle 30 fitted to a case body 10 which has a size required for containing a golf equipment 11. IN a stationary state, it is stood still with a supporting portion 40, which is provided at a prescribed position, placed an the ground, and to use it, a user grips the handle 30 and tilts the vehicle 1 with the wheels 20 as fulcrums to run it. An arrow in FIG. 2 indicates a traveling direction of the powered manual propelling vehicle 1 when traveling.

The case body 10 is formed by screwing or riveting a cylindrical member of resin or cloth to an aluminum frame. The handle 30 is mounted on the case body 10 foldably or detachably.

This powered manual propelling vehicle 1 is also provided with a motor 50 for driving the wheels 20, a battery 60 as a power source for the motor 50 and a control section 70 for controlling the motor 50. It is devised to reduce a burden on the user by driving the wheels 20 by the motors 50 when the user grips the handle 30 and travels with the vehicle 1 tilted with the wheels 20 as fulcrums.

The battery 60 is a secondary battery which can be charged and discharged and, specifically, a NiCad battery, a nickel metal hydride battery or a lithium-ion battery is used. The battery 60 is set to have a capacity enough to provide enough power considering an average power required for playing one round of golf. In this embodiment, a total weight of the motor 50 and the battery 60 is set to be 5 kg or less.

Besides, the powered manual propelling vehicle 1 of this embodiment is distributes its weight such that a total center of gravity G₁ is substantially on a vertical line L intersecting an axis of rotation of the wheels 20 when traveling. By configuring in this way, a burden on the user when traveling can be reduced as much as possible. Especially, a center of gravity G₂ combining both the motor 50 and the battery 60 is set to be located at a position opposite to the handle 30 with respect to the vertical line L intersecting the axis of rotation of the wheels 20 considering the entire layout.

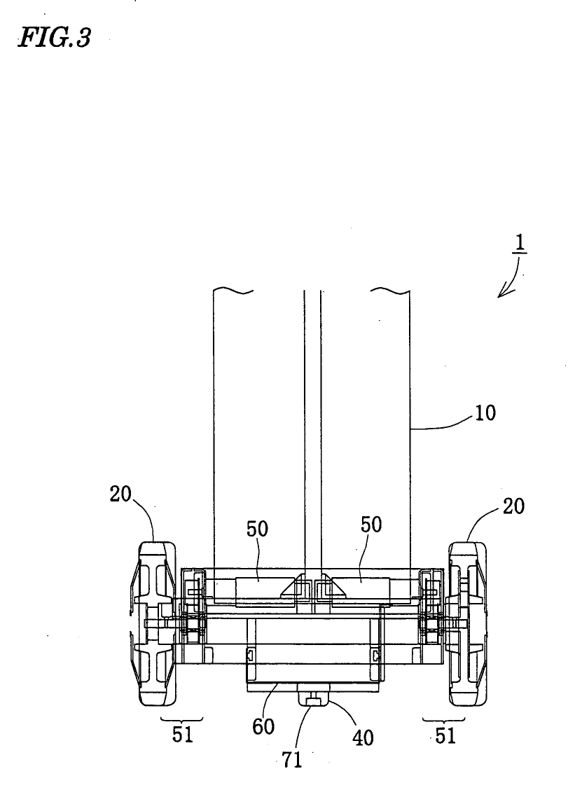

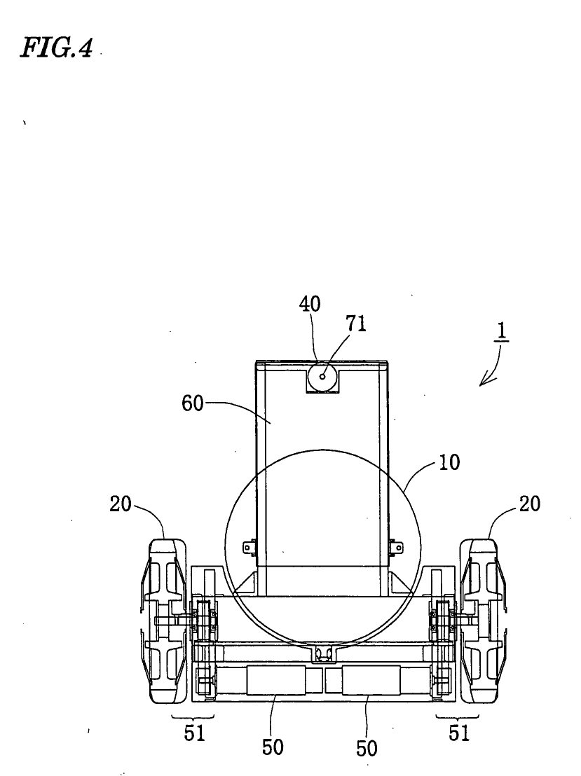

As shown in FIG. 3 and FIG. 4, the wheels 20 each is a pneumatic rubber tire or a resin wheel disk around which urethane rubber is burned and disposed on either side at a lower portion of the powered manual propelling vehicle 1.

The motor 50 and the battery 60 are disposed between the wheels 20 when viewed from the front side of the powered manual propelling vehicle 1. And, the motor 50 are disposed for each of the wheels 20. The motor 50 used is a DC motor or a DC blushless motor which is small and lightweight and provided with a gear head consisting of reduction gears.

And, the wheels 20 each is coupled to the motor 50 through a reduction mechanism 51 consisting of a timing belt and a pulley and rotated in a prescribed direction as the motor 50 is controlled by the control section 70. By configuring in this way, a high torque can be realized for the individual wheels 20. When it is configured to control the individual motors 50 separately by the control section 70, it is also possible to improve a steering property such as a change of direction or the like by their differential movement.

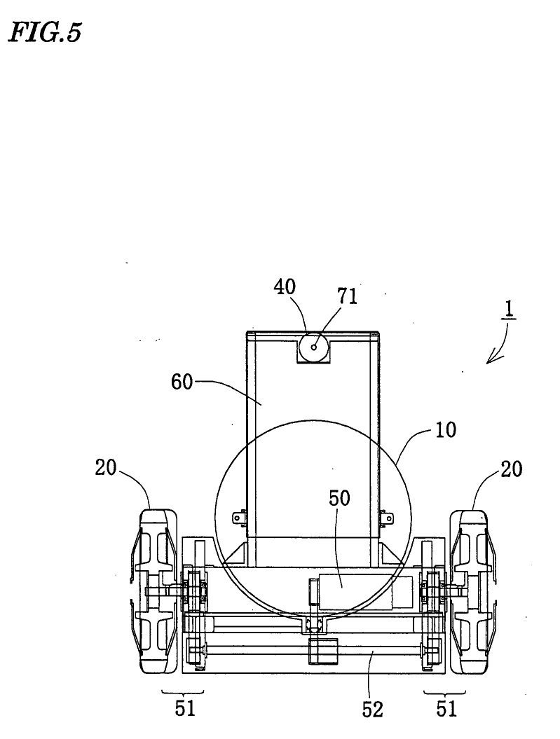

For a simplified structure of the motor 50, the wheels 20 on both sides may be configured to be driven by a single motor 50 as shown in FIG. 5. The motor 50 shown in FIG. 5 rotates a shaft 52 whose both ends are supported by individual reduction mechanisms 51.

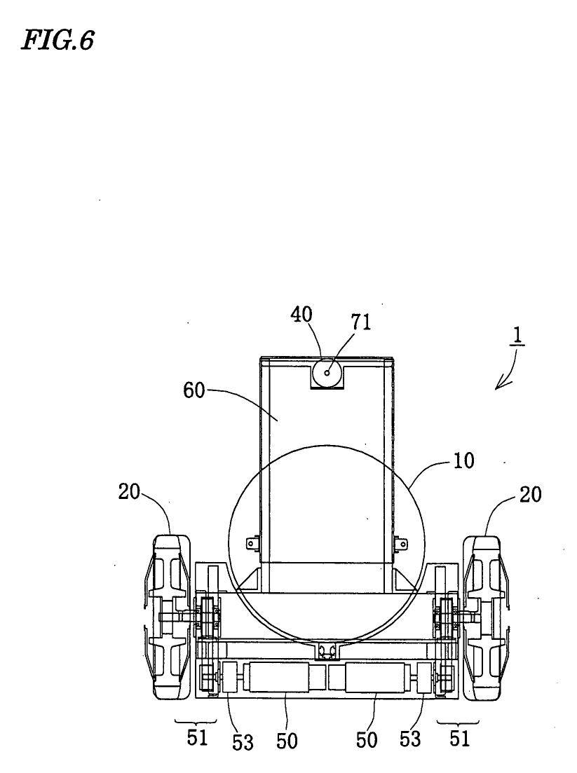

As shown in FIG. 6, a clutch 53 such as an electromagnetic clutch or a one-way clutch may be disposed between the motor 50 and the wheel 20. When the electromagnetic clutch is used to couple the motor 50 and the wheel 20, a driving force between the motor 50 and the wheel 20 can be cut off as required to improve the convenience of the powered manual propelling vehicle 1 furthermore. For example, if the battery is dead, a load of pulling the vehicle with the motor 50 not is the driving state can be decreased. And, a one-way clutch may be used between the motor 50 and the wheel 20.

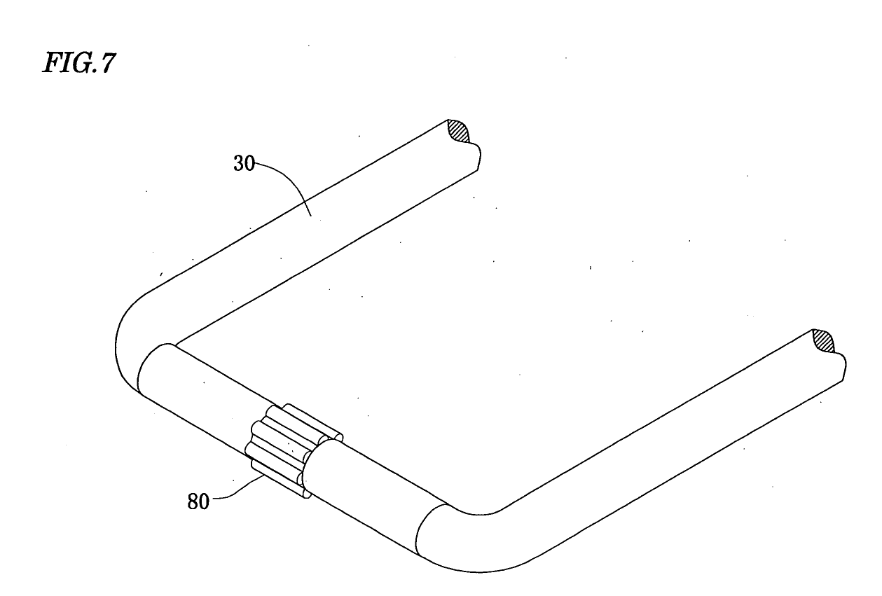

As shown in FIG. 7, the handle 30 is provided with a manual switch 80 for controlling the motor 50. The manual switch 80 shown in FIG. 7 is a rotary switch which is operated by rotating about the axial direction of the handle. Specifically, the control section 70 controls the motor 50 according to the manual switch 80 operated by the user.

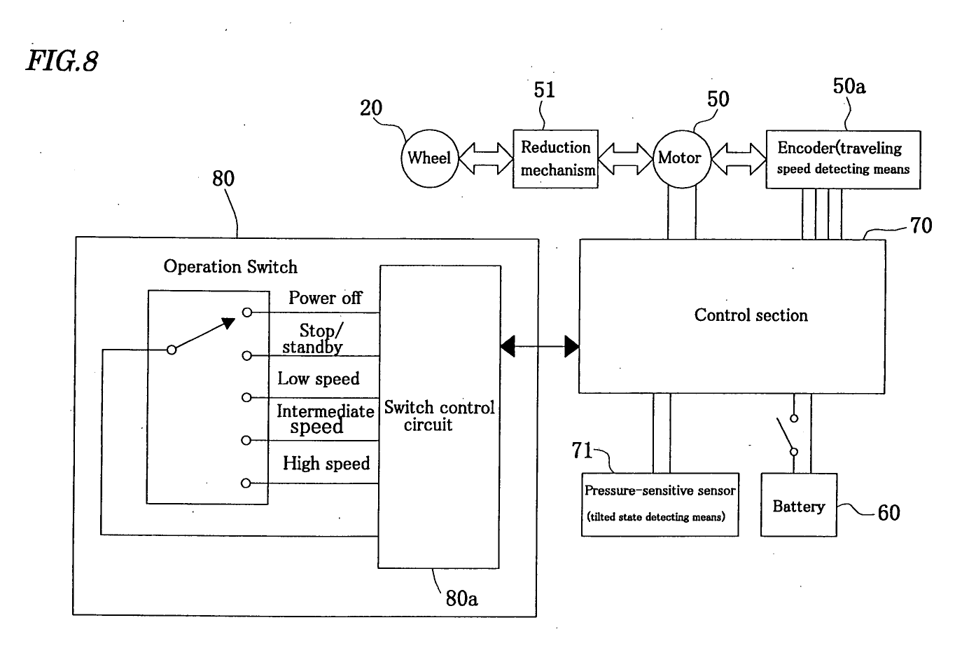

Specifically, the manual switch 80 is a five-stage rotary switch and can be selected among five modes of power off, stop/standby, a low speed, a middle speed and a high speed as shown in FIG. 8. An output of each switch state is input to a switch control circuit 80a to decide an operation mode of an assist golf bag.

The switch control circuit 80a outputs information such as activation, stop or speed as a motor control signal according to the decided operation mode to the control section 70. The control section 70 controls the activation, stop or speed of the motors 50 according to the motor control signal input from the switch control circuit 80a.

The motor 50 has an encoder 50a attached to the axis of rotation. The control section 70 inputs pulse output from the encoder 50a according to the rotations of the motor 50, counts a number of pulse within a prescribed time interval, calculates its rotation speed and performs feedback control to adjust to a speed designated by the motor control signal.

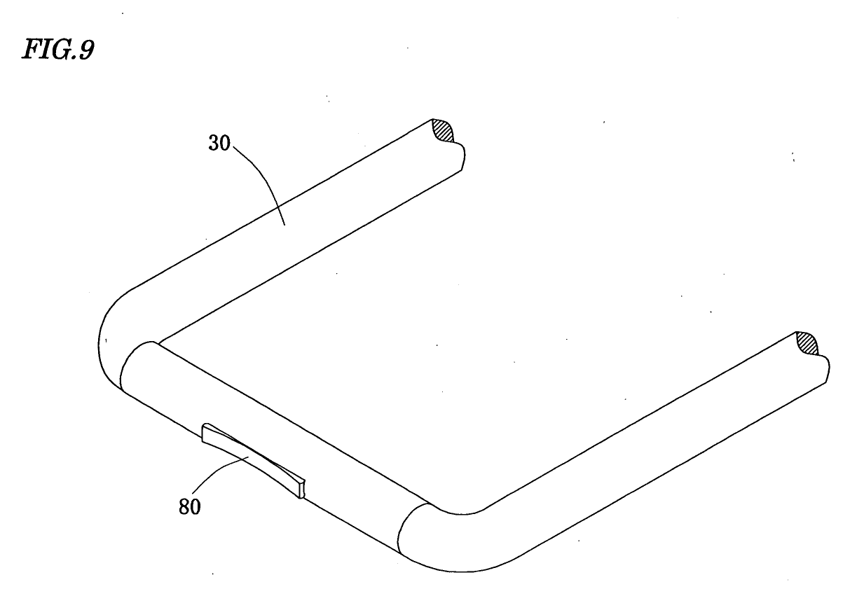

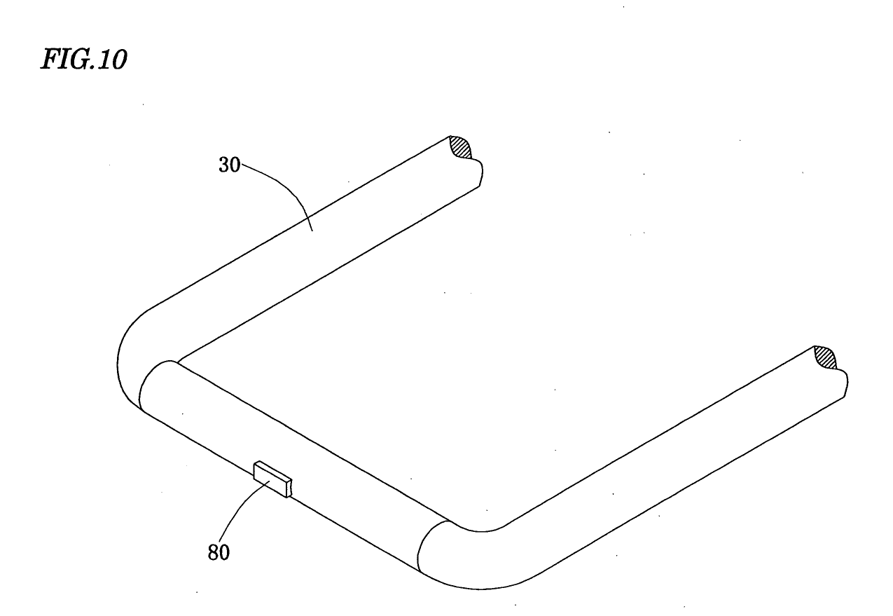

The manual switch 80 may be a seesaw switch (see FIG. 9), a push switch (see FIG. 10) or the like in addition to the rotary switch.

A tilted state detecting means for detecting the tilted state of the powered manual propelling vehicle 1 is provided in this embodiment. And, the control section 70 controls the motor 50 according to the tilted state of the powered manual propelling vehicle 1 detected by the tilted state detecting means.

Specifically, the tilted state detecting means comprises a pressure-sensitive sensor 71 which is mounted on the supporting portion 40 or its portion touched to the ground. When the powered manual propelling vehicle 1 is in a prescribed stop state, the pressure-sensitive sensor 71 is in contact with the ground, and the control section 70 stops the motor 50 regardless of the operation of the manual switch 80. By configuring in this way, a needless operation of the motor 50 can be prevented.

The tilted state detecting means can also be configured with a gyroscopic sensor disposed on a required portion of the powered manual propelling vehicle 1. When the gyroscopic sensor is used to configure the tilted state detecting means, it may be configured to drive the motor 50 only when a tilted angle of the powered manual propelling vehicle 1 is in a prescribed range.

Besides, a module (not shown), which is capable of communicating with the outside, is disposed on a required portion of the powered manual propelling vehicle 1 in this embodiment so to receive and transmit information about the play of golf.

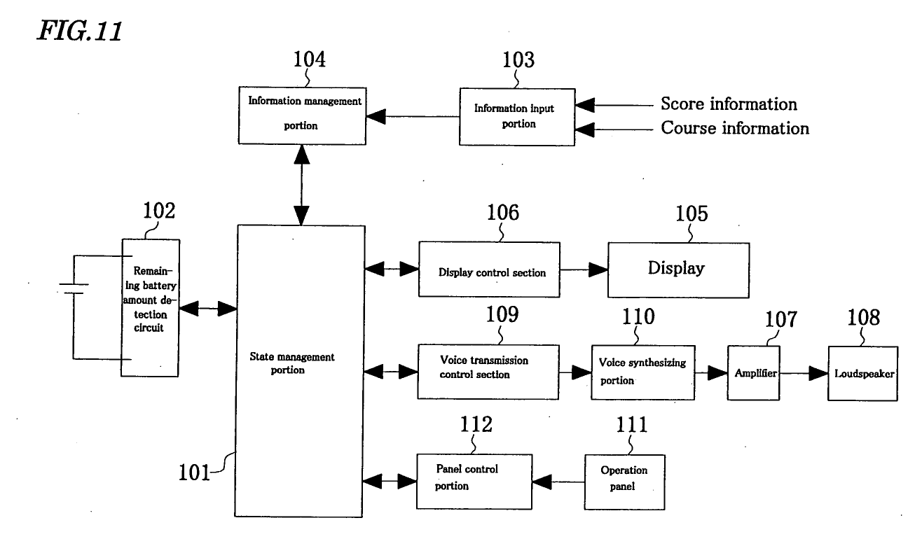

FIG. 11 is a diagram showing a configuration of information communications between the vehicle and the outside, specifically showing a state of the battery 60 and an example of communications with the outside about a course information,a score information, a fee accounting information and the like.

FIG. 11 shows a state management portion 101 which manages the state of the powered manual propelling vehicle 1, a remaining battery amount detection circuit 102 which detects the remaining battery amount and outputs is to the state management portion 101, an information input portion 103 which receives the score information and the course information from the outside to exchange them, an information management portion 104 which manages information to be exchanged with the outside by the information input portion 103 and outputs the information to the state management portion 101, a display control section 106 which controls a signal for outputting the output from the state management portion 101 to a display 105, a voice transmission control section 109 which processes a signal for outputting by voice the output from the state management portion 101 through an amplifier 107 and a loudspeaker 108, a voice synthesizing portion 110 which synthesizes voice, an operation panel 111 which selects which state of the state management portion 101 is output, and a panel control section 112 which processes the signal from the operation panel 111 and outputs it to the state management portion 101.

For example, when the battery state indicating function is selected on the operation panel 111, the state management portion 101 takes the remaining battery amount from the remaining battery amount detection circuit 102, holds it and indicates the current remaining battery amount in a numeral or a graph on the display 105 through the display control section 106.

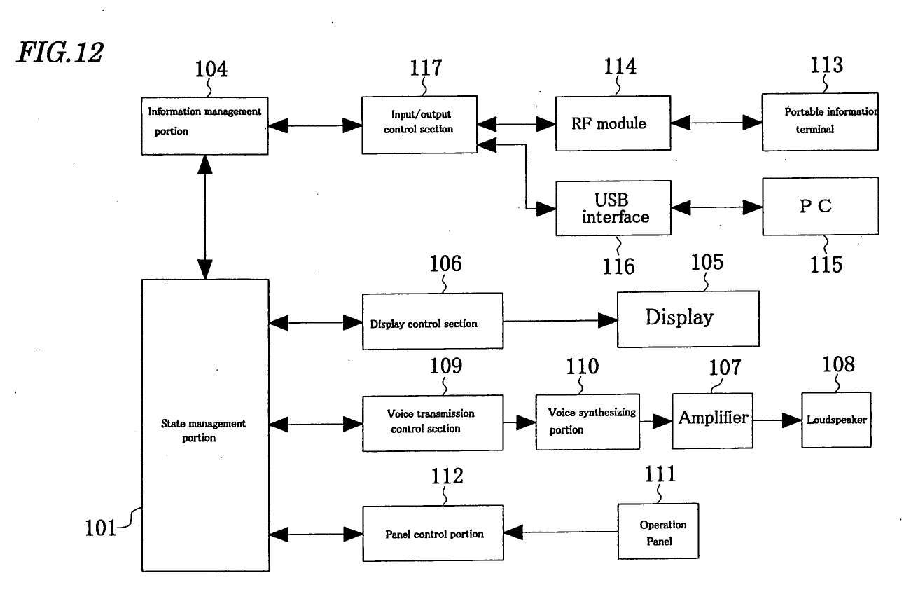

FIG. 12 is an explanatory diagram showing an example of having noncontact input/output means such as an RF module or an IR module or contact input/output means such as a USB interface as outside output means which inputs and outputs a play support information such as a course map and settlement information, and an outside data such as a golf course management information and the like.

FIG. 12 shows the state management portion 101 which manages the state of the powered manual propelling vehicle 1, the display control section 106 which outputs to display the state on the display 105, the voice transmission control section 109 which processes a voice signal for outputting by voice the state of the state management portion 101 through the amplifier 107 and the loudspeaker 108, the voice synthesizing portion 110 which synthesizes voice, the operation panel 111 which selects which state is output, a user interface section consisting of the panel control section 112 which processes the signal from the operation panel 111 and outputs it to the state management portion 101, the information management portion 104 which manages information to be input and output as means for inputting and outputting information from the outside to the user interface section, an RF module 114 which communicates data with a portally information terminal 113 without contacting, a USB interface 116 which communicates data from a PC 115 by contact type connection, and an input/output control section 117 which communicates data from plural interfaces of the RF module 114 and the USB interface 116.

For example, when the course information data is taken from the portally information terminal 113 and displayed, the course information data transmitted from the portally information terminal 113 by the noncontact RF method is received by the RF module 114, processed by the input/output control section 117, and accumulated in the information management portion 104. When the display of the course information is selected on the operation panel 111, a course information display instruction is given to the state management portion 101 via the panel control section 112, and the state management portion 101 calls the course information data from the information management portion 104, processes the data and displays the course information on the display 105 via the display control section 106.

As described above, the powered manual propelling vehicle 1 of this embodiment drives the wheels 20 by the motor 50 to achieve the remarkable effect of reducing a burden on the user when traveling and can be used quite suitably as a golf bag for carrying a golf equipment. This golf bag allows playing golf smoothly without having a dedicated caddy or an on-board type golf cart and can also contribute to saving of the play fee. The structure of the powered manual propelling vehicle 1 of this embodiment can also be applied to a traveling suitcase and other various types of bags.

The wheels 20, the handle 30, the motor 50, the battery 60 and the control section 70 may be unitized by mounting to a prescribed frame.

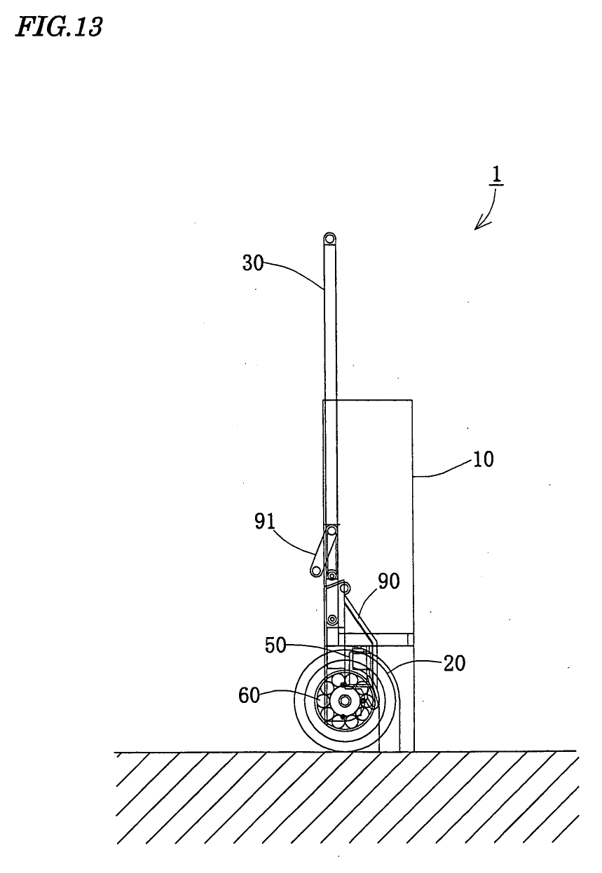

Then, a second embodiment of the present invention will be described with reference to FIG. 13 to FIG. 15.

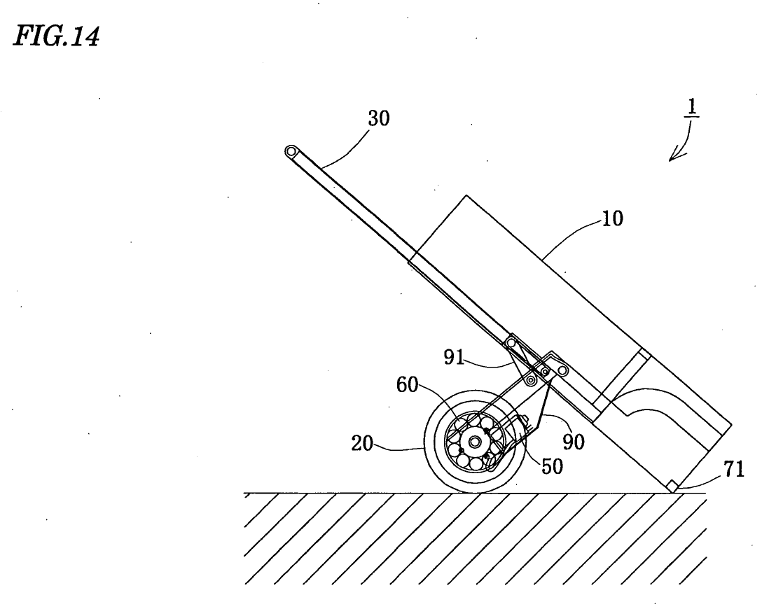

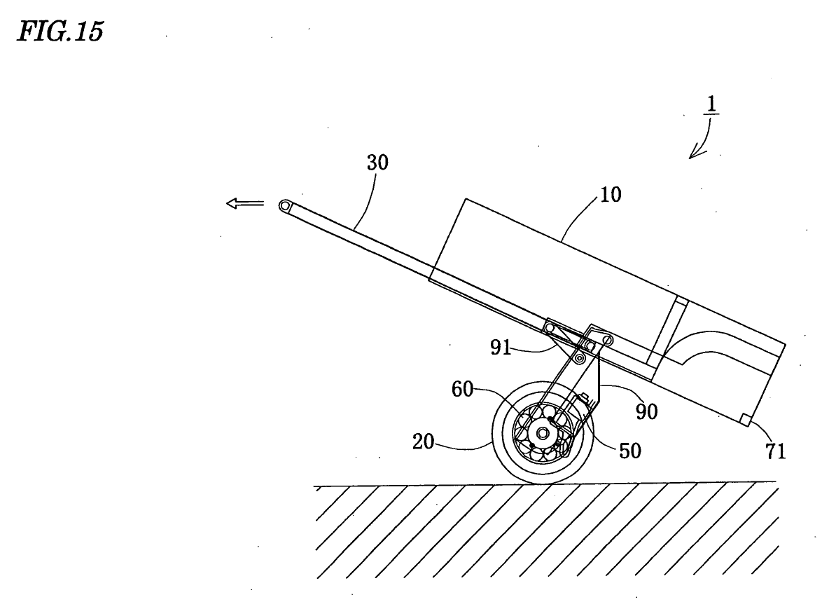

As shown in the drawings, the powered manual propelling vehicle 1 of this embodiment has a carrier 90 to which the wheels 20, the motor 50 and the battery 60 are mounted, and the carrier 90 is attached foldably to the case body 10. FIG. 13 shows the carrier 90 in the folded state, FIG. 14 shows the carrier 90 in the opened state when the vehicle is stopped and FIG. 15 shows a traveling state.

The carrier 90 is rotatably supported by the case body 10 and, when it is opened, it is fixed by engaging with a locking portion 91 which is disposed on a prescribed position. The carrier 90 is provided with ushing means such as a spring and can be interlocked with the handle 30, such that it can be folded or opened by operating the handle 30. The other basic configuration is the same as in the above-described embodiment.

By configuring as described above, the powered manual propelling vehicle 1 can be made compact as required and quite convenient. The powered manual propelling vehicle 1 of this embodiment can be folded and housed in the trunk of an automobile.

The traveling mechanism including the wheels 20 and the motor 50, the battery 60 and a control board may be unitized by mounting on the carrier 90. Especially, it is desirable that the traveling mechanism is modularized. The unitized elements are connected by a harness for the power and a harness for the signal line.

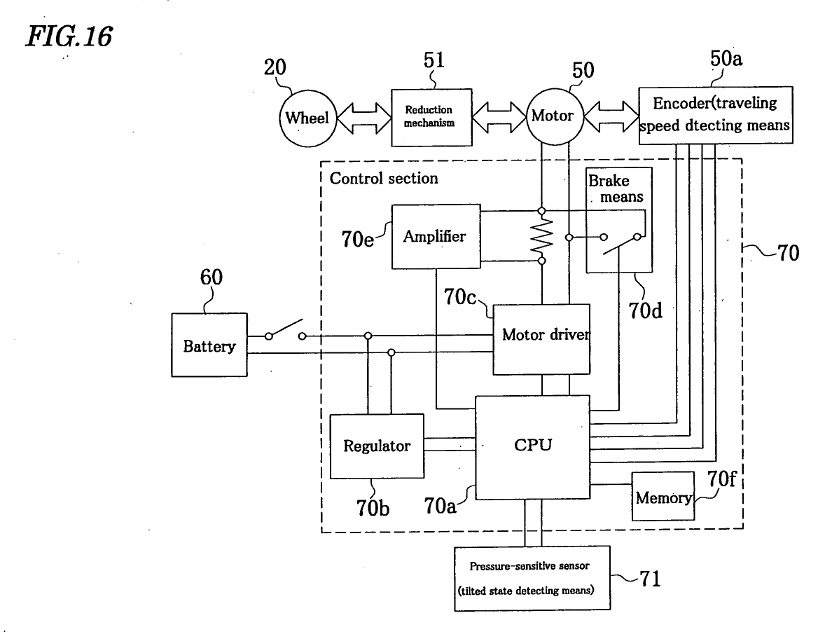

Then, a third embodiment of the present invention will be described with reference to FIG. 16 to FIG. 19.

The powered manual propelling vehicle 1 of this embodiment is provided with a traveling speed detecting means for detecting its traveling speed, and the control section 70 sets a target traveling speed of the vehicle 1 and an upper limit of torque of the motor 50 according to the traveling speed detected by the traveling speed detecting means, and controls the motor 50 such that the traveling speed agrees with the target traveling speed in a range that the torque of the motor 50 does not exceed its upper limit.

In this embodiment, the encoder 50a is used as the traveling speed detecting means. The traveling speed is detected by converting the speed ratio of the wheels 20 and the motor 50 and the circumferences of the wheels 20 into the rotation speeds of the motors 50. The other basic structures are the same as in the above-described embodiment.

In this embodiment, the control section 70 includes a CPU 70a which is connected to the battery 60 via a regulator 70b for adjusting a voltage, a motor driver 70c which sends a current to the motor 50 according to a PWM signal output from the CPU 70a, a brake means 70d which causes a short circuit of both ends of the coil of the motor 50, an amplifier 70e which detects a back electromotive force produced in the motor 50, and a memory 70f which stores a prescribed data required for controlling the motor 50 as shown in FIG. 16. The brake means 70d is configured of a plurality of semiconductor switches.

The CPU 70a sets the target traveling speed according to the detected traveling speed and outputs the PWM signal such that the rotation speed of the motor 50 agrees with the target traveling speed. The memory 70f stores in advance a preferable relationship between the traveling speed and the target traveling speed, and the CPU 70a sets the target traveling speed according to it.

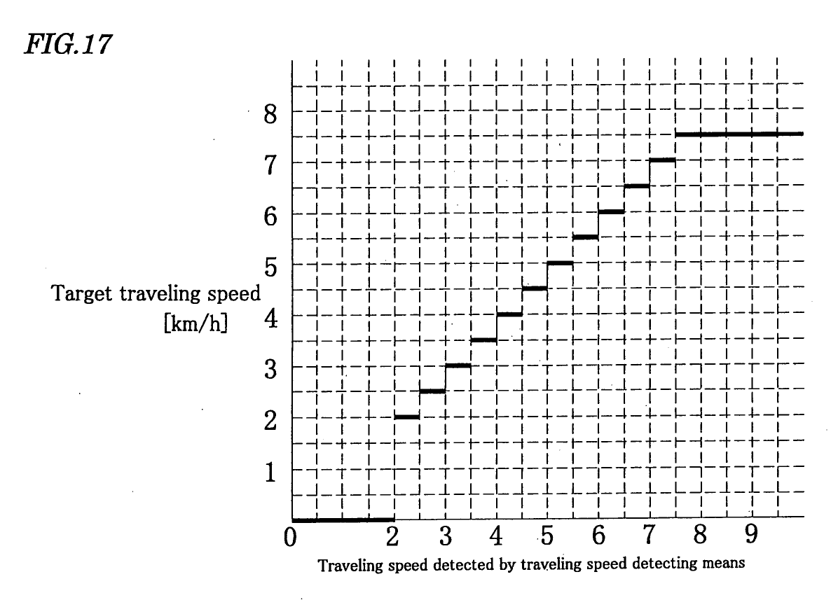

FIG. 17 is an example of a graph showing their relationship. The target traveling speed is set in stages according to the traveling speed. And, the target traveling speed is the traveling speed or less.

The torque of the motor 50 is adjusted by ON duty of the pulse of the PWM signal. The upper limit of the ON duty is determined for each target traveling speed.

Specifically, the upper limit of the torque of the motor 50 is determined according to the traveling speed. The preferable relationship between the target traveling speed and the ON duty is stored in the memory 70f, in advance, and the CPU 70a outputs the PWM signal according thereto so that the traveling speed agrees with the target traveling speed in a range that the ON duty does not exceed a prescribed upper limit.

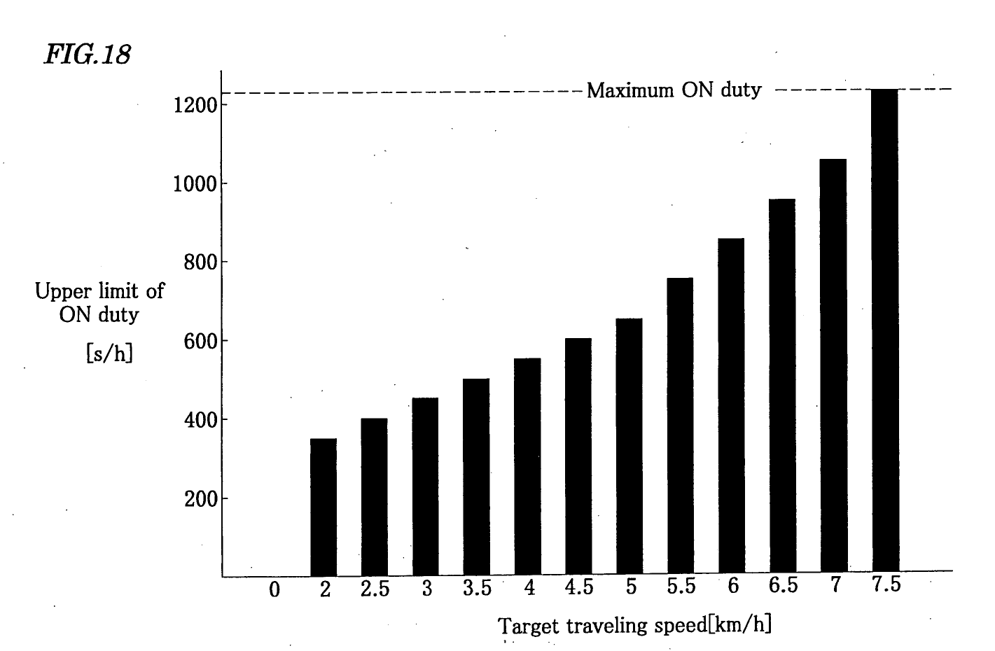

FIG. 18 is an example of a graph showing a relationship between the target traveling speed and the ON duty of FIG. 17. The upper limit of the ON duty rises as the target traveling speed becomes fast and lowers as it becomes slow.

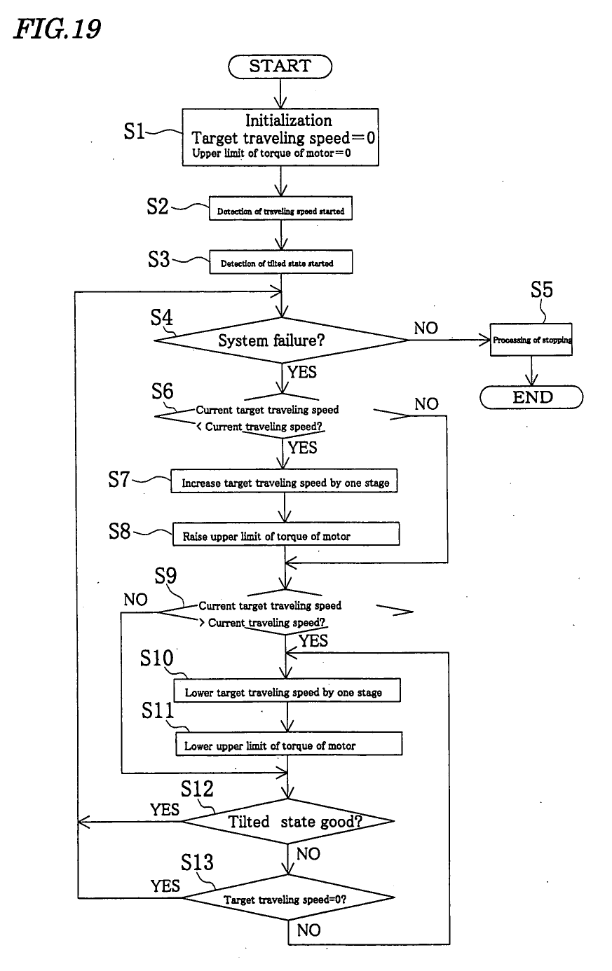

The control of the motor 50 by the control section 70 of this embodiment is conducted as indicated by the flow chart of FIG. 19.

First, when the circuit is powered on, the control is initialized (S1). When initializing, the target traveling speed and the upper limit of the torque of the motor 50 (namely, the upper limit of the ON duty)are set to zero. Besides, the detection of the traveling speed by the encoder 50a is started (S2), and the detection of the tilted state by the pressure-sensitive sensor 71 or the gyroscopic sensor is started (S3).

And, the motor 50 is controlled while checking whether the system for controlling the motor 50 is free from a defect resulting from the back electromotive force or the like which is detected by the amplifier 70e (S4). For example, when the back electromotive force is detected excessively, it is judged as a defect, and processing of stopping the motor 50 is performed (S5).

The target traveling speed and the upper limit of the torque of the motor 50 are set according to the detected traveling speed. Specifically, when the current target traveling speed is smaller than the detected current traveling speed (S6), the target traveling speed is increased by one stage (S7), and the upper limit of the torque of the motor 50 is raised (S8). This is when the user manually accelerates the powered manual propelling vehicle 1. The powered manual propelling vehicle 1, which is once accelerated, travels while keeping the target traveling speed.

The powered manual propelling vehicle 1 of this embodiment is accelerated manually, so that it is very advantageous in view of the reduction of power consumption. The traveling speed is preferably detected as an average value in a prescribed time span because the traveling speed may fluctuate largely instantaneously depending on the effect of uneven surfaces of the ground.

When the current target traveling speed is larger than the detected current traveling speed (S9), the target traveling speed is lowered by one stage (S10), and the upper limit of the torque of the motor 50 is lowered (S11). This is a case where the user applies a load on the self-traveling powered manual propelling vehicle 1 to decelerate it forcibly. In other words, the control section 70 newly sets the target traveling speed and the upper limit of the torque of the motor 50 according to the decelerated traveling speed. The traveling speed of the powered manual propelling vehicle 1 does not increase against the user's will.

Besides, the control of the motor 50 associated with the acceleration or deceleration made manually, is performed while checking the tilted state of the powered manual propelling vehicle 1 detected by the tilted state detecting means (S12). If the tilted state is not in a prescribed state and the target traveling speed is larger than zero (S13), the target traveling speed is lowered immediately. By configuring in this way, safety can be improved with certainty.

As described above, the powered manual propelling vehicle 1 of this embodiment can realize the control of the motor 50 suitable for the user's will, and the powered manual propelling vehicle 1 having an outstanding operability can be obtained.

The upper limit of the torque of the motor 50 is set in advance assuming the weight of the powered manual propelling vehicle 1 when it is traveling. Specifically, when the assumed weight is heavy, the upper limit of the torque is made high, and when it is lightweight, the upper limit of the torque is lowered. In reality, however, the weight of the powered manual propelling vehicle 1 might change greatly depending on the loaded amount of baggage. Accordingly, the powered manual propelling vehicle 1 may be provided with weight detecting means, and plural relationships between the target traveling speed and the upper limit of the torque of the motor 50 are provided in the memory 70f so that a suitable relationship is selected according to the weight detected by the weight detecting means. Otherwise, it may be configured to calculate a suitable relationship according to the weight detected by the weight detecting means whenever necessary.

Where the motor 50 and the wheel 20 are mutually coupled via a one-way clutch, the motor 50 is energized in a prescribed rotating direction by a small amount of current even if the target traveling speed is zero to prevent a situation that the motor 50 and the wheel 20 fail to engage. By configuring in this way, the traveling speed can be detected by the encoder 50a even if the powered manual propelling vehicle is accelerated manually. Specially, a value of prescribed minimum current flowing to the motor 50 for each target traveling speed is set in advance, so that it can be judged that the acceleration is being made manually if the actual electric current value becomes lower than the minimum electric current value.

Besides, the powered manual propelling vehicle 1 of this embodiment has been described to be traveled in backward and forward directions only, but it may be configured such that, when it is manually propelled backward, the brake means 70d operates to suppress its speed from becoming excessive. It is also possible to configure such that the wheels 20 are driven in forward and backward directions by the motor 50.

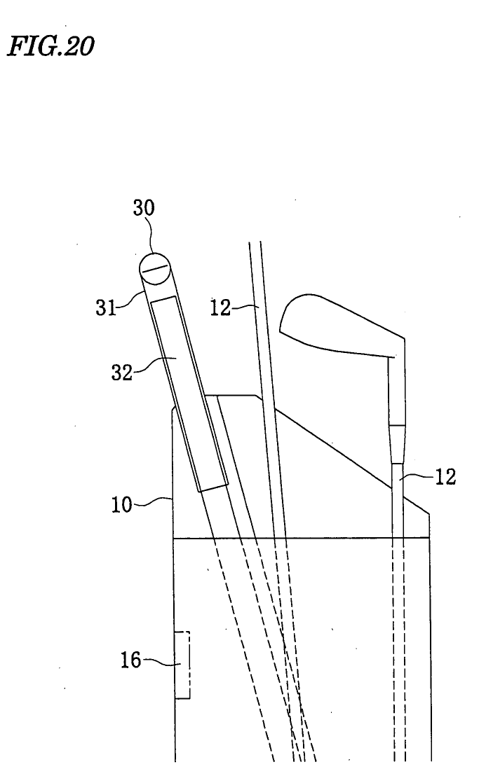

FIG. 20 shows another example of this embodiment. FIG. 20 shows the forward and 31 of the handle 30 configured to be slidable and has a liquid crystal display 32 mounted on the founded end end 31. The liquid display 32 can display data such as date and hour, weather forecast, a temperature, humidity, a wind speed, time of sunset and the like, information from the club house, a golf club management information which will be described later, and an appropriate data.

The liquid crystal display 32 mounted on the sliding handle is arranged to position within the case body 10 when the handle is retracted. Thus, the liquid crystal display 32 is protected by being covered with the case body 10.

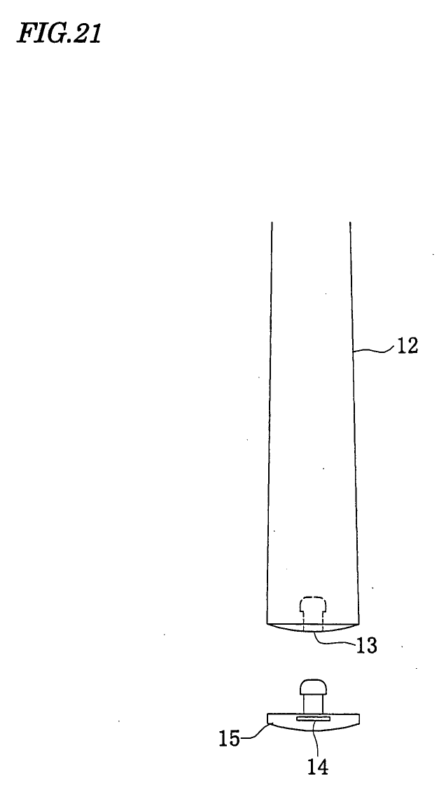

FIG. 21 shows another example of this embodiment. FIG. 21 shows that an IC chip is fitted to the grip of a golf club, so that if the golf club is left behind when playing, the problem can be solved.

Specifically, an attachment 15 on which the IC chip 14 is mounted is fitted in a hole 13 formed in the grip end of the golf club 12, and an antenna 16 is disposed in an appropriate position of the case body 10 as shown in FIG. 20. When the IC chip 14 passes near the antenna 16, an identification code of the IC chip is detected by a detection device (not shown). Thus, it is recognized that the golf club 12 is removed from or returned to the case body 10.

The IC chip and its detection device may be used to show, for example, the removal of the golf club 12 from or its return to the case body 10, on the liquid crystal display 32.

When the removed golf club 12 is not returned to the case body 10 and the powered manual propelling vehicle 1 runs, it may be notified to the player by means for judging the movement, for example, by voice or displaying on the liquid crystal display 32 according to a motor rotation signal or the like.

The IC chip and its detection device are not limited to be mount on the powered manual propelling vehicle 1 of this embodiment but may also be mounted on an ordinary caddie cart.

### INDUSTRIAL APPLICABILITY

The powered manual propelling vehicle of the present invention is applied to a manual propelling vehicle whose handle is gripped by a user to move in a tilted style with the wheels as fulcrums and used for a carry bag for a golf caddie bag, traveling suitcase and the like, a cart for carrying golf bags, and the like.

FIG. 8
20 Wheel
51 Reduction mechanism
50 Motor
50a Encoder (traveling speed detecting means)
70 Control section
71 Pressure-sensitive sensor (leaned state detecting means)
60 Battery
80 Operation switch
Power off
Stop/standby
Low speed
Intermediate speed
High speed
80a Switch control circuit

FIG. 11
102 Remaining battery amount detection circuit
104 Information management portion
101 State management portion
103 Information input portion
Score information
Course information
106 Display control section
105 Display
109 Voice transmission control section
110 Voice synthesis portion
107 Amplifier
108 Loudspeaker
112 Panel control portion
111 Operation panel

FIG. 12
104 Information management portion
101 State management portion
117 Input/output control section
114 RF module
113 Personal digital assistant
116 USB interface
115 PC
106 Display control section
105 Display
109 Voice transmission control section
110 Voice synthesis portion
107 Amplifier
108 Loudspeaker
112 Panel control portion
111 Operation panel 5

FIG. 16
20 Wheel
51 Reduction mechanism
50 Motor
50a Encoder (traveling speed detecting means)
60 Battery
70 Control section
70e Amplifier
70d Brake means
70c Motor driver
70b Regulator
70a CPU
70f Memory
71 Pressure-sensitive sensor (leaned state detecting means)

FIG. 17
Target traveling speed
Traveling speed detected by traveling speed detecting means

FIG. 18
Maximum ON duty
Upper limit of ON duty
Target traveling speed

FIG. 19
S1 Initialization
Target traveling speed=0
Upper limit of torque of motor=0
S2 Detection of traveling speed started
S3 Detection of leaned state started
S4 System failure?
S5 Processing of stopping
S6 Current target traveling speed<Current traveling speed?
S7 Increase target traveling speed by one stage
S8 Raise upper limit of torque of motor
S9 Current target traveling speed>Current traveling speed?
S10 Lower target traveling speed by one stage
S11 Lower upper limit of torque of motor
S12 Leaned state good?
S13 Target traveling speed=0?

1. In a golf bag having a case body for containing a golf equipment,
an electric golf bag having the case body provided with wheels, a motor for driving the wheels, a battery as a power source for the motor and a control section for controlling the motor, the golf bag itself being configured to be propellable, wherein:
the golf bag distributes its weight such that a center of gravity of the entire golf bag is positioned substantially on a vertical line intersecting an axis of rotation of the wheels when the golf bag is running.

2. The electric golf bag according to claim 1, wherein the weight of the entire golf bag is a weight including a baggage loaded.

3. The electric golf bag according to claim 1, wherein the centers of gravity of the motor and the battery are positioned on the side opposite to the handle with respect to a vertical line intersecting the axis of rotation of the wheels when the golf bag is running.

4. (canceled)

5. The electric golf bag according to claim 1, further comprising a carrier which in provided with the motor for driving the wheels, a battery as a power source for the motor and the wheels, and the case body is provided with the carrier.

6. The electric golf bag according to claim 5, wherein the carrier is mounted foldably.

7. The electric golf bag according to claim 1, wherein the wheels are disposed as a pair on both sides, and the motors are disposed each for each of the pair of wheels disposed on both sides.

8. The electric golf bag according to any one of claims 1 to 3 and 5 to 7, wherein the motor, the battery and the control section are connected by a harness for the power or a harness for a signal line.

9. The electric golf bag according to any one of claims 1 to 3 and 5 toog wherein the handle is provided with a manual switch for operating the motor.

10. The electric golf bag according to claim 9, wherein the manual switch is a rotary switch, a seesaw switch or a push switch.

11. The electric golf bag according to claim 1, wherein the control section has a traveling speed detecting means for detecting the traveling speed of the golf bag, and the control section also sets the target traveling speed of the golf bag and the upper limit of the torque of the motor according to the traveling speed detected by the traveling speed detecting means, and controls the motor such that the traveling speed agrees with the target traveling speed within a range that the torque of the motor does not exceed the upper limit of the torque.

12. The electric golf bag according to any one of claims 1 to 3 and 5 to 11, wherein the motor and the wheels are coupled via an electromagnetic clutch.

13. The electric golf bag according to any one of claims 1 to 3 and 5 to 12, wherein the motor and the wheels are coupled via a one-way clutch.

14. (canceled)

15. The electric golf bag according to any one of claims 1 to 3 and 5 to 14, wherein the golf bag is provided with a module capable of communicating with the outside.

16. The electric golf bag according to any one of claims 1 to 3, 5 to 13 and 15, wherein the forward end the handle is slidable, and a liquid crystal display is mounted on the forward end.

17. The electric golf bag according to claim 16, wherein the liquid crystal display is so provided to be portioned within the case body when the handle is retracted.

18. The electric golf bag according to any one of claims 1 to 3, 5 to 13 and 15 to 17, wherein a golf club is housed in the case, an IC chip is attached to the grip end of the golf club, an antenna is mounted on the case body, a detection device for detecting an identification code of the IC chip is provided, and the identification code of the IC chip is detected by the detection device to identify the movement of the golf club when the IC chip passes near the antenna.

19. The electric golf bag according to claim 18, further comprising means for judging the movement of the golf bag, wherein the detection device detects that the golf club is not returned to the case body and issues a voice or shows on the liquid crystal display according to the means which judges the movement of the cart
